(19) United States
(12) Patent Application Publication
(10) Pub. No.: US 2023/0300720 A1
(43) Pub. Date: Sep. 21, 2023

(54) NETWORK DISTRIBUTION METHOD AND APPARATUS

(71) Applicant: Beijing Unisoc Communications Technology Co., Ltd., Beijing (CN)

(72) Inventors: Ru Zhang, Beijing (CN); Shilei Yu, Beijing (CN); Xuebo Wei, Beijing (CN); Bin Chen, Beijing (CN); Yanchao Xu, Beijing (CN)

(21) Appl. No.: 18/041,395

(22) PCT Filed: Jul. 29, 2021
(86) PCT No.: PCT/CN2021/109350

§ 371 Date: Feb. 10, 2023

(30) Foreign Application Priority Data
Aug. 10, 2020 (CN) 202010797981.2

(51) Int. Cl. H04W 48/08; H04W 48/16

(52) U.S. Cl. CPC H04W 48/08; H04W 48/16

(57) ABSTRACT

The present disclosure discloses a network distribution method. The method comprises: obtaining network distribution data of a target router sent from a second terminal; determining, according to the network distribution data of the target router, a service set identifier (SSID) of the target router encoded in a first encoding method and an SSID of the target router encoded in a second encoding method; and accessing the target router according to the SSID of the target router encoded in the first encoding method and the SSID of the target router encoded in the second encoding method.

This application is a National Stage of International Application No. PCT/CN2021/109350, filed on Jul. 29, 2021, which claims priority to Chinese patent application No. 202010797981.2, entitled “NETWORK DISTRIBUTION METHOD AND APPARATUS” filed on Aug. 10, 2020 in the China National Intellectual Property Administration, the contents of which are incorporated herein by reference in their entireties.

### TECHNICAL FIELD

The present disclosure relates to the technical field of information, and in particular to a network distribution method and apparatus.

### BACKGROUND

With development of the mobile Internet and Internet of Things technologies, and the trend towards the Internet of everything, more terminal devices need to use wireless fidelity (WiFi) to connect to routers to carry out remote control through the network. A terminal device may generally connect to a router in an application using a network distribution solution (such as AirKiss).

### SUMMARY

Embodiments of the present disclosure provide a network distribution method and apparatus.

In a first aspect, an embodiment of the present disclosure provides a network distribution method, applied to a first terminal and including:

obtaining network distribution data of a target router sent from a second terminal;

determining, according to the network distribution data of the target router, a service set identifier (SSID) of the target router encoded in a first encoding method and an SSID of the target router encoded in a second encoding method; and

accessing the target router according to the SSID of the target router encoded in the first encoding method and the SSID of the target router encoded in the second encoding method.

In a second aspect, an embodiment of the present disclosure provides a network distribution method, applied to a second terminal and including:

generating network distribution data of a target router, where the network distribution data is used to determine a service set identifier (SSID) of the target router encoded in a first encoding method and an SSID of the target router encoded in a second encoding method; and

sending the network distribution data of the target router to a first terminal.

In a third aspect, the present disclosure also provides an electronic device, including:

a processor; and

a memory, configured to store a computer program of the processor;

where the processor, by executing the computer program, is configured to:

obtain network distribution data of a target router sent from a second terminal;

determine, according to the network distribution data of the target router, an SSID of the target router encoded in a first encoding method and an SSID of the target router encoded in a second encoding method; and

access the target router according to the SSID of the target router encoded in the first encoding method and the SSID of the target router encoded in the second encoding method.

In a fourth aspect, the present disclosure also provides an electronic device, including:

a processor; and

a memory, configured to store a computer program of the processor;

where the processor is configured to implement any one of the possible methods of the second aspect by executing the computer program.

According to the network distribution method and apparatus provided in an embodiment of the present disclosure, a first terminal firstly obtains network distribution data of a target router sent from a second terminal. Then, the first terminal determines, according to the network distribution data of the target router, a service set identifier (SSID) of the target router encoded in a first encoding method and an SSID of the target router encoded in a second encoding method. Finally, the first terminal accesses the target router according to the SSID of the target router encoded in the first encoding method and the SSID of the target router encoded in the second encoding method.

### BRIEF DESCRIPTION OF THE DRAWINGS

In order to illustrate the technical solutions of the present disclosure or in the related art more clearly, a brief description will be given below with reference to the accompanying drawings used in the description of the embodiments or the related art. It is obvious that the accompanying drawings described below are merely some of the embodiments of the present disclosure, and those skilled in the art may obtain other drawings according to these accompanying drawings without involving any creative effort.

FIG. 1 is a schematic diagram of an application scenario of a network distribution method provided in an embodiment of the present disclosure.

FIG. 2 is a diagram illustrating signaling interaction of a network distribution method provided in an embodiment of the present disclosure.

FIG. 3 is a flowchart of a network distribution method provided in an embodiment of the present disclosure.

FIG. 4 is a schematic diagram of a target frame provided in an embodiment of the present disclosure.

FIG. 5 is a schematic diagram of another target frame provided in an embodiment of the present disclosure.

FIG. 6 is a flowchart of another network distribution method provided in an embodiment of the present disclosure.

FIG. 7 is a flowchart of yet another network distribution method provided in an embodiment of the present disclosure.

FIG. 8 is a schematic structural diagram of a network distribution apparatus provided in an embodiment of the present disclosure.

FIG. 9 is a schematic structural diagram of another network distribution apparatus provided in an embodiment of the present disclosure.

FIG. 10 is a schematic structural diagram of an electronic device provided in an embodiment of the present disclosure.

### DESCRIPTION OF EMBODIMENTS

In order to make the objects, technical solutions and advantages of the embodiments of the present disclosure clearer, the technical solutions in the embodiments of the present disclosure will be clearly and completely described in conjunction with the accompanying drawings of the embodiment of the present disclosure. Obviously, the described embodiments are merely a part of the embodiments of the present disclosure, but not all of the embodiments. Based on the embodiments of the present disclosure, all other embodiments obtained by a person skilled in the art without involving any creative efforts will fall within the protection scope of the present disclosure.

In the related art, a terminal device needs to obtain a service set identifier (SSID) and a password of a router when connecting to the router. There are many encoding methods for Chinese SSIDs of routers, and the commonly used encoding methods are 8-bit unicode transformation format (UTF-8) and Chinese internal code specification (GBK).

However, when connecting to the router, an application will default that the encoding method of the SSID is UTF-8 encoding, so that the application will send the information of the SSID in the UTF-8 method even when the encoding method of Chinese SSID of the router is GBK encoding, thereby causing network distribution failure of the terminal device.

In order to solve the above problems, the present disclosure provides a network distribution method and apparatus. As there are two commonly used encoding methods, the present disclosure provides the SSIDs of the target router encoded in the above-mentioned two encoding methods in the network distribution data. In the process of network distribution, if a terminal fails to access a router with the SSID of the target router encoded in the first encoding method, the terminal may also try to access the router with the SSID of the target router encoded in the second encoding method, thereby reducing the possibility of network distribution failure.

Application scenarios of the present disclosure are described below.

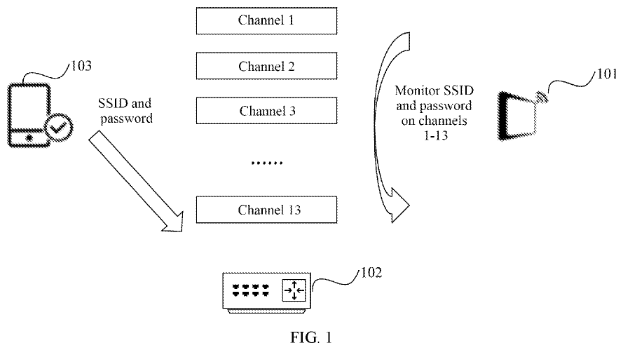

FIG. 1 is a schematic diagram of an application scenario of a network distribution method provided in an embodiment of the present disclosure. As shown in FIG. 1, a second terminal 103 has successfully accessed the target router 102. Then, if the second terminal 103 wants to inform the first terminal 101 of the SSID of the target router and the password, the encoded SSID and password of the target router 102 may be sent on any one of the channels of the target router 102 using a network distribution solution (such as AirKiss). The first terminal 101 monitors various channels of the target router 102 in real time, obtains the SSID and password of the target router 102 from the channels, and accesses the target router 102 according to the obtained SSID and password of the target router 102.

The first terminal 101 and the second terminal 103 may be a mobile phone, a pad, a computer with wireless transceiving functions, a virtual reality (VR) terminal device, an augmented reality (AR) terminal device, a wireless terminal in industrial control, a wireless terminal in a remote medical surgery, a wireless terminal in a smart grid, a wireless terminal in a smart home, etc. In the embodiments of the present disclosure, the apparatus for implementing the functions of a terminal may be a terminal device, or an apparatus capable of supporting the terminal to implement the functions, such as a chip system, which can be installed in the terminal device. In the embodiments of the present disclosure, the chip system may be composed of chips, and may also include chips and other discrete components.

It should be noted that the application scenario of the technical solution of the present disclosure may be the scenario in FIG. 1, but is not limited thereto, and the technical solution of the present disclosure may also be applied to other scenarios requiring network distribution.

It is to be understood that the network distribution method described above may be implemented by the network distribution apparatus provided in the embodiments of the present disclosure, or the network distribution apparatus may be part or all of a device, for example, the first terminal, the second terminal, a processor of the first terminal, or a processor of the second terminal.

The technical solutions of the embodiments of the present disclosure will be described in detail below by taking a first terminal and a second terminal integrated with or installed with associated execution code as an example. The first terminal involved in the embodiments described below may be the first terminal 101 in FIG. 1, and the second terminal involved in the embodiments described below may be the second terminal 103 in FIG. 1. The following specific embodiments may be combined with one another, and the like or similar concepts or processes may not be repeated in some embodiments.

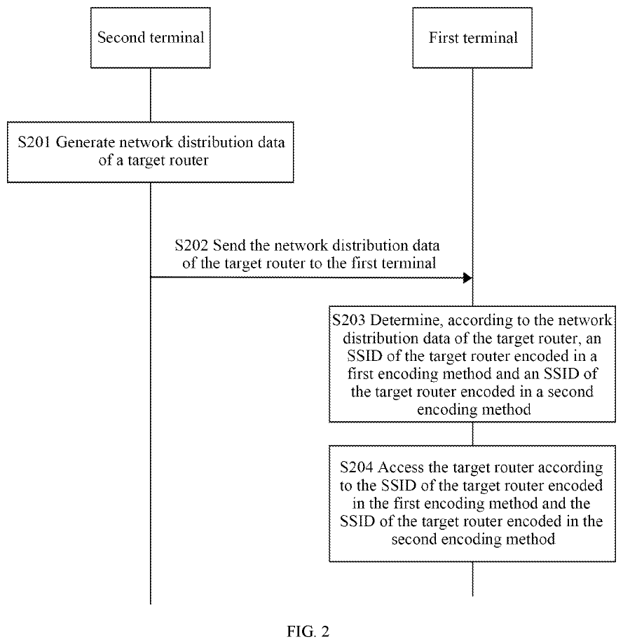

FIG. 2 is a diagram illustrating signaling interaction of a network distribution method provided in an embodiment of the present disclosure. The present embodiment relates to a specific process of how a first terminal accesses a target router according to network distribution data provided by a second terminal. As shown in FIG. 2, the method includes the following steps.

In S201, a second terminal generates network distribution data of a target router, where the network distribution data is used to determine a service set identifier (SSID) of the target router encoded in a first encoding method and an SSID of the target router encoded in a second encoding method.

The network distribution data is used to determine the SSID of the target router encoded in the first encoding method and the SSID of the target router encoded in the second encoding method.

Embodiments of the present disclosure do not limit the types of the first encoding method and the second encoding method. For example, the first encoding method in the embodiments of the present disclosure may be the UTF-8 encoding method, and the second encoding method may be the GBK encoding method.

In the present disclosure, after having successfully accessed the target router, the second terminal may inform the first terminal of the SSID and the password of the target router by sending the network distribution data to the first terminal, so that the first terminal can access the target router.

The embodiments of the present disclosure also do not limit how to generate the network distribution data. In some embodiments, after obtaining the SSID of the target router stored in the second terminal, the second terminal may first determine whether an encoding method of the SSID of the target router stored in the second terminal is the first encoding method or not. If not, the second terminal fails to determine the encoding method of the SSID of the target router, and then the second terminal generates the network distribution data of the target router according to both the SSID of the target router encoded in the first encoding method and the SSID of the target router encoded in the second encoding method. If so, the second terminal may determine that the encoding method of the SSID of the target router is the first encoding method, and then the second terminal may generate the network distribution data of the target router merely according to the SSID of the target router encoded in the first encoding method.

In addition, since the password of the router is usually required in the process of accessing the router, the network distribution data may also include the password of the target router.

In S202, the second terminal sends the network distribution data of the target router to the first terminal.

The present disclosure does not limit how the second terminal sends the network distribution data of the target router to the first terminal, for example, over-the-air technology and the like may be adopted. In some embodiments, the second terminal may send the network distribution data of the target router to the first terminal through a WiFi target frame and target sequence of the target router. Correspondingly, the first terminal may monitor the WiFi target frame and target sequence, and obtain the network distribution data of the target router sent from the second terminal from the WiFi target frame and target sequence of the target router.

In S203, the first terminal determines the SSID of the target router encoded in the first encoding method and the SSID of the target router encoded in the second encoding method according to the network distribution data of the target router.

In this step, after obtaining the network distribution data of the target router sent from the second terminal, the first terminal determines the SSID of the target router encoded in the first encoding method and the SSID of the target router encoded in the second encoding method according to the network distribution data of the target router.

The embodiments of the present disclosure do not limit how to determine the SSID of the target router encoded in the first encoding method and the SSID of the target router encoded in the second encoding method from the network distribution data. In some embodiments, the first terminal may obtain auxiliary information from the target frame, and determine, according to the auxiliary information, the SSID of the target router encoded in the first encoding method and the SSID of the target router encoded in the second encoding method from the target sequence.

The auxiliary information includes at least one of: a string length of the target sequence, a check value of the SSID, and indicative information of an encoding method of the SSID.

Furthermore, since the network distribution data also includes the password of the target router, the auxiliary information further includes a password length and a check value of the password length. Correspondingly, the first terminal may determine the password of the target router from the target sequence according to the password length and the check value of the password length.

In S204, the first terminal accesses the target router according to the SSID of the target router encoded in the first encoding method and the SSID of the target router encoded in the second encoding method.

In this step, after determining the SSID of the target router encoded in the first encoding method and the SSID of the target router encoded in the second encoding method according to the network distribution data of the target router, the first terminal accesses the target router according to the SSID encoded in the above-mentioned two encoding methods.

In some embodiments, the first terminal may first try to access the target router using an SSID encoded in one encoding method, and if the access fails, access the target router using an SSID encoded in another encoding method.

Illustratively, the first terminal sends a first access request to the target router, the first access request includes an SSID of the target router encoded in the first encoding method and the password of the target router. After receiving the first access request, the target router tries to identify the SSID of the target router encoded in the first encoding, and verifies the password of the target router. If the target router succeeds in identification and the password is verified as correct, the first terminal accesses the target router. Then, the target router may send an access feedback to the first terminal, the access feedback indicates a successful access to the target router.

Illustratively, if the target router does not successfully identify the SSID of the target router encoded in the first encoding method, an error feedback is sent to the first terminal, the error feedback indicates that the target router fails to identify the SSID of the target router encoded in the first encoding method. Then, the first terminal sends a second access request to the target router, the second access request includes the SSID of the target router encoded in the second encoding method and the password of the target router. After receiving the second access request, the target router tries to identify the SSID of the target router encoded in the second encoding and verifies the password of the target router. If the target router succeeds in identification and the password is verified as correct, the first terminal accesses the target router. Then, the target router may also send an access feedback to the first terminal, the access feedback indicates a successful access to the target router.

According to the network distribution method provided in the embodiment of the present disclosure, a first terminal firstly obtains network distribution data of a target router sent from a second terminal. Then, the first terminal determines, according to the network distribution data of the target router, a service set identifier (SSID) of the target router encoded in a first encoding method and an SSID of the target router encoded in a second encoding method. Finally, the first terminal accesses the target router according to the SSID of the target router encoded in the first encoding method and the SSID of the target router encoded in the second encoding method. Compared with the related art, the network distribution method provided in the present disclosure configures the SSID of the target router in two encoding methods in the network distribution data, such that upon the reception of the network distribution data from the second terminal, the first terminal can try to access the router with SSIDs encoded in different encoding methods, thereby reducing the possibility of network distribution failure.

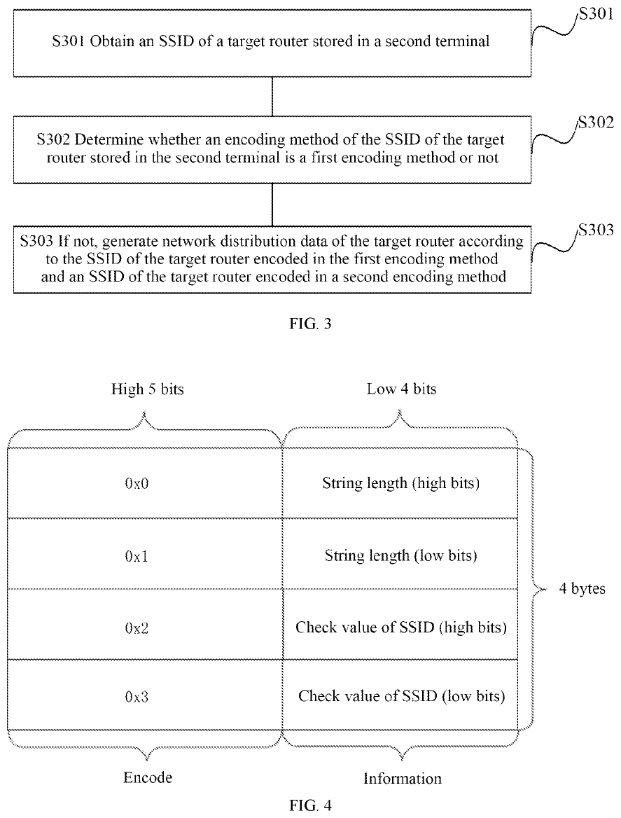

On the basis of the above embodiments, the following will describe how the second terminal generates network distribution data. FIG. 3 is a flowchart of a network distribution method provided in an embodiment of the present disclosure, which is implemented by the second terminal. As shown in FIG. 3, the network distribution method includes the following steps.

In S301, the second terminal obtains an SSID of a target router stored in the second terminal.

The embodiments of the present disclosure do not limit how to obtain the SSID of the target router stored in the second terminal, and a suitable obtaining method may be adopted according to actual situations.

In S302, the second terminal determines whether an encoding method of the SSID of the target router stored in the second terminal is a first encoding method or not.

In some embodiments, the second terminal may perform transcoding on the SSID of the target router stored in the second terminal using the second encoding method, so as to determine whether the encoding method of the SSID of the target router stored in the second terminal is the first encoding method or not.

Illustratively, if the SSID before transcoding is the same as the SSID after transcoding, it may be determined that the encoding method of the SSID of the target router stored in the second terminal is the first encoding method, and then the network distribution data only needs to include the SSID of the target router encoded in the first encoding method. If the SSID before transcoding and the SSID after transcoding are different, it cannot be determined whether the SSID of the target router stored in the second terminal is encoded in the first encoding method or not, and then the network distribution data needs to include the SSID of the target router encoded in the first encoding method and the SSID of the target router encoded in the second encoding method.

In S303, if not, the second terminal generates network distribution data of the target router according to the SSID of the target router encoded in the first encoding method and an SSID of the target router encoded in a second encoding method.

In some embodiments, since the second terminal sends the network distribution data of the target router to the first terminal through a WiFi target frame and target sequence of the target router, correspondingly, the network distribution data may be generated according to the target frame and target sequence.

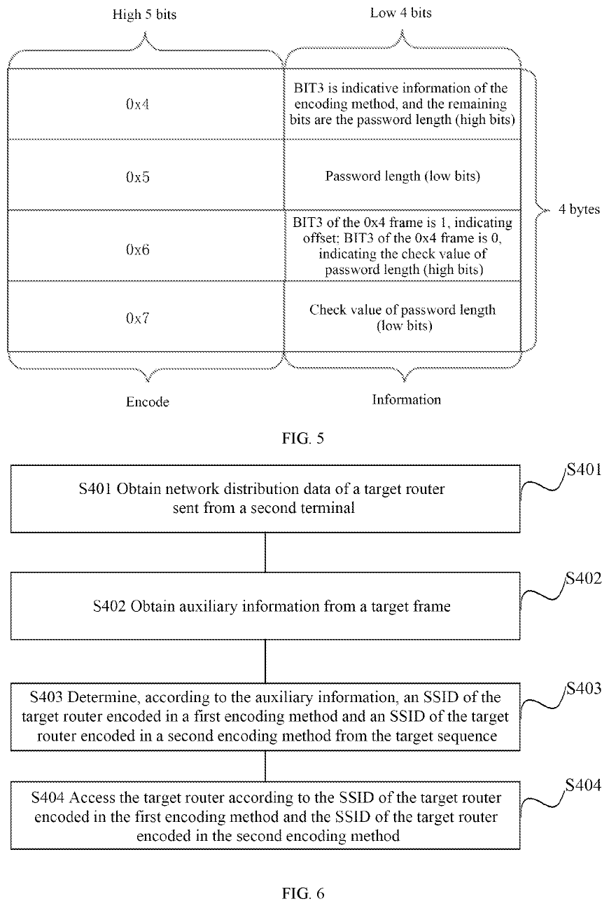

Illustratively, FIG. 4 is a schematic diagram of a target frame provided in an embodiment of the present disclosure, and FIG. 5 is a schematic diagram of another target frame provided in an embodiment of the present disclosure. As shown in FIGS. 4 and 5, among the eight target frames, the second terminal may use 0x0 frame and 0x1 frame each having nine bits to record a string length of the target sequence, and the string length length is as shown in Formula (1):

length=len(UTF-8_SSID+Random+pwd)+offset (1)

where len( ) is a string length, pwd is a password, Random is a random number, UTF-8_SSID is the SSID encoded in the first encoding method, and offset is a compensation value.

The second terminal may record a check value of the SSID with 0x2 frame and 0x3 frame each having nine bits. A third bit (BIT3) in 0x4 frame may be used as indicative information of the encoding method of the SSID. Illustratively, if BIT3=1, it indicates that the second terminal cannot determine the encoding method of the SSID of the target router, and then, both the SSID of the target router encoded in the first encoding method and the SSID of the target router encoded in the second encoding method need to be sent, and accordingly, offset !=0. If BIT3=0, it indicates that the second terminal can determine that the encoding method of the SSID of the target router is the first encoding method, and then, only the SSID of the target router encoded in the first encoding method needs to be sent, and accordingly, offset=0. In addition, the remaining bits of the 0x4 frame other than BIT3 and 0x5 frame may be configured to record the password length.

0x6 frame represents the high bits of the check value of the password length. If BIT3=0 in the 0x4 frame, then the 0x6 frame represents the low bits of the check value of the password length. If BIT3=1 in 0x4 frame, then 0x6 frame represents offset. As the length of SSID≤32, and commonly used Chinese characters can be represented by 3 bytes in UTF-8 or 2 bytes in GBK, the SSID of the target router has at most 10 Chinese characters, and the corresponding offset≤10.

The target sequence may be, for example, a Sequence. The target sequence must contain a password, a random number and the SSID of the target router encoded in the first encoding method. If offset=0, it does not need to send the SSID of the target router encoded in the second encoding method. If offset !=0, then it needs to send the SSID of the target router encoded in the second encoding method. The string length of the SSID of either coding method in the target sequence may be determined by Formula (2) or Formula (3).

len(UTF-8_SSID)=length−pwd length−1−offset (2)

len(GBK SSID)=len(UTF-8_SSID)offset (3)

UTF-8_SSID is an SSID encoded in the first encoding method, GBK SSID is an SSID encoded in the second encoding method, and pwd length is the password length.

In some embodiments, if it cannot be determined that the encoding method of the SSID of the target router stored in the second terminal is the first encoding method, the network distribution data of the target router may be generated according to the SSID of the target router encoded in the first encoding method.

It is to be noted that if the above offset !=0, it does not need to send the SSID of the target router encoded in the second encoding method.

On the basis of the above-mentioned embodiments, the following will describe how the first terminal obtains the SSID of the target router encoded in the first encoding method and the SSID of the target router encoded in the second encoding method from the network distribution data. FIG. 6 is a flowchart of another network distribution method provided in an embodiment of the present disclosure, which is implemented by the first terminal. As shown in FIG. 6, the network distribution method includes the following steps.

In S401, the first terminal obtains network distribution data of a target router sent from a second terminal.

The technical terms, technical effects, technical features, and embodiments of S401 can be understood with reference to S201 shown in FIG. 2, and like contents will not be repeated here.

In S402, the first terminal obtains auxiliary information from the target frame, where the auxiliary information includes at least one of: a string length of target sequence, a check value of an SSID, and indicative information of an encoding method of the SSID.

Corresponding to the above embodiments, the first terminal may obtain the string length of the target sequence from the 0x0 frame and the 0x1 frame; the check value of the SSID from the 0x2 frame and 0x3 frame; indicative information of the encoding method of the SSID from BIT3 of the 0x4 frame; the password length of the target router from the 0x4 frame and the 0x5 frame; from the 0x6 frame, the offset if BIT3 is 1, and high bits of the check value of the password length if BIT3 is 0; and low bits of the check value of the password length from the 0x7 frame.

In S403, the first terminal determines, according to the auxiliary information, an SSID of the target router encoded in a first encoding method and an SSID of the target router encoded in a second encoding method from the target sequence.

In the present disclosure, after obtaining the auxiliary information from the target frame, the first terminal may determine the SSID of the target router encoded in the first encoding method and the SSID of the target router encoded in the second encoding method from the target sequence according to the auxiliary information.

The embodiments of the present disclosure do not limit how to determine the SSID of the target router encoded in the first encoding method and the SSID of the target router encoded in the second encoding method from the target sequence according to the auxiliary information, and any common methods may be adopted.

In S404, the first terminal accesses the target router according to the SSID of the target router encoded in the first encoding method and the SSID of the target router encoded in the second encoding method.

The technical terms, technical effects, technical features, and embodiments of S404 can be understood with reference to S204 shown in FIG. 2, and like contents will not be repeated here.

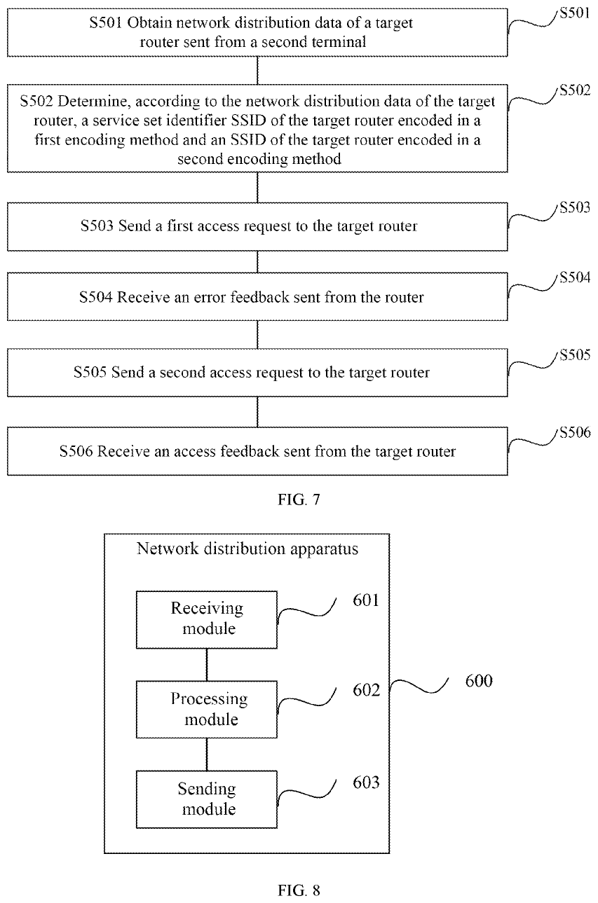

On the basis of the above-mentioned embodiments, the process of how the first terminal accesses the target router using the SSIDs of two encoding methods is described below. FIG. 7 is a flowchart of yet another network distribution method provided in an embodiment of the present disclosure, which is implemented by the first terminal. As shown in FIG. 7, the network distribution method includes the following steps.

In S501, the first terminal obtains network distribution data of a target router sent from a second terminal.

In S502, the first terminal determines, according to the network distribution data of the target router, a service set identifier SSID of the target router encoded in a first encoding method and an SSID of the target router encoded in a second encoding method.

In S503, the first terminal sends a first access request to the target router, where the first access request includes the SSID of the target router encoded in the first encoding method and a password of the target router.

In this step, after the first access request is sent, if an access feedback sent from the target router is received, the target router is successfully accessed.

In S504, the first terminal receives an error feedback sent from the router, where the error feedback is used to indicate that the target router fails to identify the SSID of the target router encoded in the first encoding method.

In S505, the first terminal sends a second access request to the target router, where the second access request includes the SSID of the target router encoded in the second encoding method and the password of the target router.

In S506, the first terminal receives an access feedback sent from the target router, where the access feedback is used to indicate successful access to the target router.

According to the network distribution method provided in the embodiment of the present disclosure, a first terminal firstly obtains network distribution data of a target router sent from a second terminal. Then, the first terminal determines, according to the network distribution data of the target router, a service set identifier (SSID) of the target router encoded in a first encoding method and an SSID of the target router encoded in a second encoding method. Finally, the first terminal accesses the target router according to the SSID of the target router encoded in the first encoding method and the SSID of the target router encoded in the second encoding method. Compared with the related art, the network distribution method provided in the present disclosure configures the SSID of the target router in two encoding methods in the network distribution data, such that upon the reception of the network distribution data from the second terminal, the first terminal can try to access the router with SSIDs encoded in different encoding methods, thereby reducing the possibility of network distribution failure.

Those skilled in the art will appreciate that all or part of the steps implementing the above method embodiments may be performed by hardware associated with program instructions, and the program may be stored in a computer readable storage medium, and the program, when executed, performs the steps included in the above method embodiments; the above-mentioned storage medium includes: a ROM, a RAM, a magnetic disk, an optical disk, and other media capable of storing program codes.

FIG. 8 is a schematic structural diagram of a network distribution apparatus provided in an embodiment of the present disclosure. The communication apparatus may be implemented by software, hardware, or a combination thereof, for example, the first terminal or a chip of the first terminal in the above embodiments, to implement the network distribution method at the first terminal side in the embodiments described above. As shown in FIG. 8, a network distribution apparatus 600 includes:

a receiving module 601, configured to obtain network distribution data of a target router sent from a second terminal; and

a processing module 602, configured to determine, according to the network distribution data of the target router, a service set identifier (SSID) of the target router encoded in a first encoding method and an SSID of the target router encoded in a second encoding method; and access the target router according to the SSID of the target router encoded in the first encoding method and the SSID of the target router encoded in the second encoding method.

In an embodiment, the network distribution data further includes a password of the target router; and

the network distribution apparatus 600 further includes a sending module 603, configured to send a first access request to the target router, where the first access request includes the SSID of the target router encoded in the first encoding method and the password of the target router; and

the receiving module 601 is further configured to receive an access feedback sent from the target router, where the access feedback is used to indicate a successful access to the target router.

In an embodiment, the receiving module 601 is further configured to receive an error feedback sent from the router, where the error feedback is used to indicate that the target router fails to identify the SSID of the target router encoded in the first encoding method; and receive an access feedback sent from the target router, where the access feedback is used to indicate a successful access to the target router; and

the sending module 603 is further configured to send a second access request to the target router, where the second access request includes the SSID of the target router encoded in the second encoding method and the password of the target router.

In an embodiment, the receiving module 601 is specifically configured to obtain the network distribution data of the target router sent from the second terminal from a wireless fidelity (WiFi) target frame and target sequence of the target router.

In an embodiment, the processing module 602 is specifically configured to obtain auxiliary information from the target frame, where the auxiliary information includes at least one of: a string length of the target sequence, a check value of the SSID, and indicative information of an encoding method of the SSID; and determine, according to the auxiliary information, the SSID of the target router encoded in the first encoding method and the SSID of the target router encoded in the second encoding method from the target sequence.

It is to be noted that the network distribution apparatus provided in the embodiment in FIG. 8 may be configured to perform the network distribution method at the first terminal side provided in any of the embodiments described above, and the specific implementation and technical effects are similar, and will not be described in detail here.

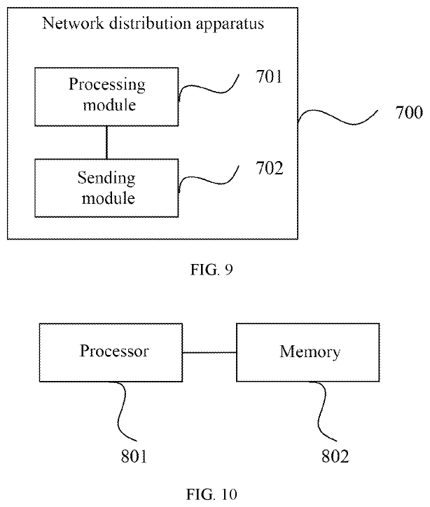

FIG. 9 is a schematic structural diagram of another network distribution apparatus provided in an embodiment of the present disclosure. The communication apparatus may be implemented by software, hardware, or a combination thereof, for example, the second terminal or a chip of the second terminal in the above embodiments, to implement the network distribution method at the second terminal side in the embodiments described above. As shown in FIG. 9, a network distribution apparatus 700 includes:

a processing module 701, configured to generate network distribution data of a target router, where the network distribution data is used to determine a service set identifier (SSID) an SSID of the target router encoded in a first encoding method and an SSID of the target router encoded in a second encoding method; and

a sending module 702, configured to send the network distribution data of the target router to a first terminal.

In an embodiment, the processing module 701 is specifically configured to obtain an SSID of the target router stored in a second terminal; determine whether an encoding method of the SSID of the target router stored in the second terminal is the first encoding method or not; if not, generate the network distribution data of the target router according to the SSID of the target router encoded in the first encoding method and the SSID of the target router encoded in the second encoding method.

In an embodiment, the sending module 702 is specifically configured to send the network distribution data of the target router to the first terminal through a wireless fidelity (WiFi) target frame and target sequence of the target router.

It is to be noted that the network distribution apparatus provided in the embodiment in FIG. 9 may be configured to perform the network distribution method at the second terminal side provided in any of the embodiments described above, and the specific implementation and technical effects are similar, and will not be described in detail here.

FIG. 10 is a schematic structural diagram of an electronic device provided in an embodiment of the present disclosure. As shown in FIG. 9, the electronic device may include: at least one processor 801 and a memory 802. FIG. 9 shows an electronic device with one processor as an example.

The memory 802 is configured to store programs. Specifically, a program may include program code including computer operating instructions.

The memory 802 may include a high-speed RAM memory, and may also include a non-volatile memory, such as at least one disk memory.

The processor 801 is configured to perform computer execution instructions stored in the memory 802 so as to implement the network distribution method at the first terminal side or the network distribution method at the second terminal side described above.

The processor 801 may be a central processing unit (CPU), or an application specific integrated circuit (ASIC), or one or more integrated circuits configured to implement embodiments of the present disclosure.

In an embodiment, in a particular implementation, if the communication interface, the memory 802 and the processor 801 are implemented independently, the communication interface, the memory 802 and the processor 801 may be interconnected and communicate with each other via a bus. The bus may be an industry standard architecture (ISA) bus, a peripheral component interconnect (PCI) bus, or an extended industry standard architecture (EISA) bus, etc. The bus may be divided into an address bus, a data bus, a control bus, etc., but does not mean that there is merely one bus or one type of bus.

In an embodiment, in a particular implementation, if the communication interface, the memory 802 and the processor 801 are implemented integrally on a single chip, the communication interface, the memory 802 and the processor 801 may communicate via internal interfaces.

In an embodiment, the apparatus may be a chip or a chip module or the like.

Any module included in the apparatus in the above embodiments may be a software module or a hardware module, or may be part of a software module and part of a hardware module. For example, for any apparatus and product applied to or integrated into a chip, the modules contained therein may be all implemented by means of hardware such as a circuit; or at least some of the modules may be implemented by means of a software program running on a processor integrated within the chip, and the remaining (if any) of the modules may be implemented by means of hardware such as a circuit. For any apparatus and product applied to or integrated in a chip module, the modules contained therein may be all implemented by means of hardware such as a circuit, and different modules may be in the same component (for example, a chip, a circuit module, etc.) or different components of the chip module; or at least some of the modules may be implemented by means of a software program running on a processor integrated within the chip module, and the remaining (if any) of the modules may be implemented by means of hardware such as a circuit. For each apparatus and product applied to or integrated in a terminal, the modules contained therein may all be implemented by means of hardware, such as a circuit, and different modules may be in the same component (such as a chip, a circuit module, etc.) or different components of the terminal; or at least some of the modules may be implemented by means of a software program running on a processor integrated within the terminal; and the remaining (if any) of the modules may be implemented by means of hardware, such as a circuit.

An embodiment of the present disclosure further provides a chip that includes a processor and an interface. The interface is configured to input and output data or instructions processed by the processor. The processor is configured to perform the network distribution method at the first terminal side or the network distribution method at the second terminal side provided in the above method embodiments. The chip may be applied in a network distribution apparatus.

The present disclosure also provides a computer readable storage medium, which may include: a U disk, a mobile hard disk, a read-only memory (ROM), a random access memory (RAM), a magnetic disk, an optical disk, or other media capable of storing program code. Specifically, the computer readable storage medium stores program information for the network distribution method at the first terminal side or the network distribution method at the second terminal side.

An embodiment of the present disclosure further provides a program which, when executed by a processor, is configured to perform the network distribution method at the first terminal side or the network distribution method at the second terminal side provided in the above method embodiments.

An embodiment of the present disclosure further provide a program product, for example, a computer readable storage medium, having stored thereon instructions which, when executed on a computer, cause the computer to perform the network distribution method at the first terminal side or the network distribution method at the second terminal side provided in the above-mentioned method embodiments.

All the above embodiments may be implemented in whole or in part by software, hardware, firmware, or any combination thereof. When implemented in software, it may be implemented in whole or in part as a computer program product. The computer program product includes one or more computer instructions. When computer program instructions are loaded and executed on a computer, all of or part of the processes or functions according to the embodiments of the present disclosure are performed. The computer may be a general-purpose computer, a special-purpose computer, a computer network, or other programmable apparatus. The computer instructions may be stored in a computer readable storage medium or sent from one computer readable storage medium to another computer readable storage medium. For example, the computer instructions may be sent from one website, computer, router, or data center to another website, computer, router, or data center in a wired (e.g. coaxial cable, fiber optic, digital subscriber line (DSL)) or wireless (e.g. infrared, wireless, microwave, etc.) manner. A computer readable storage medium may be any available medium that can be accessed by a computer or a data storage device such as a router, data center with one or more available media integrated. The available media may be magnetic media (e.g. a floppy disk, a hard disk, a magnetic tape), optical media (e.g. a digital video disk (DVD)), or semiconductor media (e.g. a solid state disk (SSD)), etc.

Embodiments of the present disclosure provide a network distribution method and apparatus to solve the problem of network distribution failure caused by different encoding methods in the related art.

In a first aspect, an embodiment of the present disclosure provides a network distribution method, applied to a first terminal and including:

obtaining network distribution data of a target router sent from a second terminal;

determining, according to the network distribution data of the target router, a service set identifier (SSID) of the target router encoded in a first encoding method and an SSID of the target router encoded in a second encoding method; and

accessing the target router according to the SSID of the target router encoded in the first encoding method and the SSID of the target router encoded in the second encoding method.

In an embodiment, the network distribution data further includes a password of the target router; and the accessing the target router, includes:

sending a first access request to the target router, where the first access request includes the SSID of the target router encoded in the first encoding method and the password of the target router; and

receiving an access feedback sent from the target router, where the access feedback is used to indicate a successful access to the target router.

In an embodiment, after the sending a first access request to the target router, the method further includes:

receiving an error feedback sent from the router, where the error feedback is used to indicate that the target router fails to identify the SSID of the target router encoded in the first encoding method;

sending a second access request to the target router, where the second access request includes the SSID of the target router encoded in the second encoding method and the password of the target router; and

receiving an access feedback sent from the target router, where the access feedback is used to indicate a successful access to the target router.

In an embodiment, the obtaining network distribution data of a target router sent from a second terminal, includes:

obtaining the network distribution data of the target router sent from the second terminal from a wireless fidelity (WiFi) target frame and target sequence of the target router.

In an embodiment, the determining a service set identifier (SSID) of the target router encoded in a first encoding method and an SSID of the target router encoded in a second encoding method, includes:

obtaining auxiliary information from the target frame, where the auxiliary information includes at least one of: a string length of the target sequence, a check value of the SSID, and indicative information of an encoding method of the SSID; and

determining, according to the auxiliary information, the SSID of the target router encoded in the first encoding method and the SSID of the target router encoded in the second encoding method from the target sequence.

In a second aspect, an embodiment of the present disclosure provides a network distribution method, applied to a second terminal and including:

generating network distribution data of a target router, where the network distribution data is used to determine a service set identifier (SSID) of the target router encoded in a first encoding method and an SSID of the target router encoded in a second encoding method; and

sending the network distribution data of the target router to a first terminal.

In an embodiment, the generating network distribution data of a target router, includes:

obtaining an SSID of the target router stored in the second terminal;

determining whether an encoding method of the SSID of the target router stored in the second terminal is the first encoding method or not; and

if not, generating the network distribution data of the target router according to the SSID of the target router encoded in the first encoding method and the SSID of the target router encoded in the second encoding method.

In an embodiment, the sending the network distribution data of the target router to a first terminal, includes:

sending the network distribution data of the target router to the first terminal through a wireless fidelity (WiFi) target frame and target sequence of the target router.

In a third aspect, an embodiment of the present disclosure provides a network distribution apparatus, including:

a receiving module configured to obtain network distribution data of a target router sent from a second terminal; and

a processing module configured to determine, according to the network distribution data of the target router, a service set identifier (SSID) of the target router encoded in a first encoding method and an SSID of the target router encoded in a second encoding method; and access the target router according to the SSID of the target router encoded in the first encoding method and the SSID of the target router encoded in the second encoding method.

In an embodiment, the network distribution data further includes a password of the target router; and

the apparatus further includes a sending module, configured to send a first access request to the target router, where the first access request includes the SSID of the target router encoded in the first encoding method and the password of the target router; and

the receiving module is further configured to receive an access feedback sent from the target router, where the access feedback is used to indicate a successful access to the target router.

In an embodiment, the receiving module is further configured to receive an error feedback sent from the router, where the error feedback is used to indicate that the target router fails to identify the SSID of the target router encoded in the first encoding method; and receive an access feedback sent from the target router, where the access feedback is used to indicate a successful access to the target router; and

the sending module is further configured to send a second access request to the target router, where the second access request includes the SSID of the target router encoded in the second encoding method and the password of the target router.

In an embodiment, the receiving module is specifically configured to obtain the network distribution data of the target router sent from the second terminal from a wireless fidelity (WiFi) target frame and target sequence of the target router.

In an embodiment, the processing module is specifically configured to obtain auxiliary information from the target frame, where the auxiliary information includes at least one of: a string length of the target sequence, a check value of the SSID, and indicative information of an encoding method of the SSID; and determine, according to the auxiliary information, the SSID of the target router encoded in the first encoding method and the SSID of the target router encoded in the second encoding method from the target sequence.

In a fourth aspect, an embodiment of the present disclosure provides a network distribution apparatus, including:

a processing module configured to generate network distribution data of a target router, where the network distribution data is used to determine a service set identifier (SSID) of the target router encoded in a first encoding method and an SSID of the target router encoded in a second encoding method; and

a sending module configured to send the network distribution data of the target router to a first terminal.

In an embodiment, the processing module is specifically configured to obtain an SSID of the target router stored in a second terminal; determine whether an encoding method of the SSID of the target router stored in the second terminal is the first encoding method or not; if not, generate the network distribution data of the target router according to the SSID of the target router encoded in the first encoding method and the SSID of the target router encoded in the second encoding method.

In an embodiment, the sending module is specifically configured to send the network distribution data of the target router to the first terminal through a wireless fidelity (WiFi) target frame and target sequence of the target router.

In a fifth aspect, the present disclosure also provides an electronic device, including:

a processor; and

a memory, configured to store a computer program of the processor;

where the processor is configured to implement any one of the possible methods of the first aspect by executing the computer program.

In a sixth aspect, the present disclosure also provides an electronic device, including:

a processor; and

a memory, configured to store a computer program of the processor;

where the processor is configured to implement any one of the possible methods of the second aspect by executing the computer program.

In a seventh aspect, the present disclosure further provides a non-transitory computer-readable storage medium storing computer instructions, having stored thereon a computer program, which, when executed by a processor, implements any one of the possible methods of the first aspect.

In an eighth aspect, the present disclosure further provides a non-transitory computer-readable storage medium storing computer instructions, having stored thereon a computer program, which, when executed by a processor, implements any one of the possible methods of the second aspect.

According to the network distribution method and apparatus provided in an embodiment of the present disclosure, a first terminal firstly obtains network distribution data of a target router sent from a second terminal. Then, the first terminal determines, according to the network distribution data of the target router, a service set identifier (SSID) of the target router encoded in a first encoding method and an SSID of the target router encoded in a second encoding method. Finally, the first terminal accesses the target router according to the SSID of the target router encoded in the first encoding method and the SSID of the target router encoded in the second encoding method. Compared with the related art, the network distribution method provided in the present disclosure configures the SSID of the target router in two encoding methods in the network distribution data, such that upon the reception of the network distribution data from the second terminal, the first terminal can try to access the router with SSIDs encoded in different encoding methods, thereby reducing the possibility of network distribution failure.

Finally, it is to be noted that: the above-mentioned embodiments are merely illustrative of the technical solution of the present disclosure, and are not restrictive. Although the present disclosure has been described in detail with reference to the foregoing embodiments, those skilled in the art will appreciate that the technical solutions disclosed in the above-mentioned embodiments may still be amended, or some or all of the technical features thereof may be replaced by equivalents, and such modifications and substitutions do not depart from the spirit and scope of the embodiments of the present disclosure.

1. A network distribution method, applied to a first terminal and comprising:
obtaining network distribution data of a target router sent from a second terminal;
determining, according to the network distribution data of the target router, a service set identifier (SSID) of the target router encoded in a first encoding method and an SSID of the target router encoded in a second encoding method; and
accessing the target router according to the SSID of the target router encoded in the first encoding method and the SSID of the target router encoded in the second encoding method.

2. The method according to claim 1, wherein the network distribution data further comprises a password of the target router; and the accessing the target router, comprises:
sending a first access request to the target router, wherein the first access request comprises the SSID of the target router encoded in the first encoding method and the password of the target router; and
receiving an access feedback sent from the target router, wherein the access feedback is used to indicate a successful access to the target router.

3. The method according to claim 2, wherein after the sending a first access request to the target router, the method further comprises:
receiving an error feedback sent from the router, wherein the error feedback is used to indicate that the target router fails to identify the SSID of the target router encoded in the first encoding method;
sending a second access request to the target router, wherein the second access request comprises the SSID of the target router encoded in the second encoding method and the password of the target router; and
receiving an access feedback sent from the target router, wherein the access feedback is used to indicate a successful access to the target router.

4. The method according to claim 1, wherein the obtaining network distribution data of a target router sent from a second terminal, comprises:
obtaining the network distribution data of the target router sent from the second terminal from a wireless fidelity (WiFi) target frame and target sequence of the target router.

5. The method according to claim 4, wherein the determining a service set identifier (SSID) of the target router encoded in a first encoding method and an SSID of the target router encoded in a second encoding method, comprises:
obtaining auxiliary information from the target frame, wherein the auxiliary information comprises at least one of: a string length of the target sequence, a check value of the SSID, and indicative information of an encoding method of the SSID; and
determining, according to the auxiliary information, the SSID of the target router encoded in the first encoding method and the SSID of the target router encoded in the second encoding method from the target sequence.

6. A network distribution method, applied to a second terminal and comprising:
generating network distribution data of a target router, wherein the network distribution data is used to determine a service set identifier (SSID) of the target router encoded in a first encoding method and an SSID of the target router encoded in a second encoding method; and
sending the network distribution data of the target router to a first terminal.

7. The method according to claim 6, wherein the generating network distribution data of a target router, comprises:
obtaining an SSID of the target router stored in the second terminal;
determining whether an encoding method of the SSID of the target router stored in the second terminal is the first encoding method or not; and
in the response to a determination that the encoding method of the SSID of the target router stored in the second terminal is not the first encoding method, generating the network distribution data of the target router according to the SSID of the target router encoded in the first encoding method and the SSID of the target router encoded in the second encoding method.

8. The method according to claim 6, wherein the sending the network distribution data of the target router to a first terminal, comprises:
sending the network distribution data of the target router to the first terminal through a wireless fidelity (WiFi) target frame and target sequence of the target router.

9. A network distribution apparatus, comprising:
a processor; and
a memory, configured to store a computer program of the processor;
wherein the processor, by executing the computer program, is configured to:
obtain network distribution data of a target router sent from a second terminal;
determine, according to the network distribution data of the target router, a service set identifier (SSID) of the target router encoded in a first encoding method and an SSID of the target router encoded in a second encoding method; and
access the target router according to the SSID of the target router encoded in the first encoding method and the SSID of the target router encoded in the second encoding method.

10. (canceled)

11. The network distribution apparatus according to claim 9, wherein the network distribution data further comprises a password of the target router; and the processor is configured to:
control a communication interface of the network distribution apparatus to send a first access request to the target router, wherein the first access request comprises the SSID of the target router encoded in the first encoding method and the password of the target router; and
control the communication interface to receive an access feedback sent from the target router, wherein the access feedback is used to indicate a successful access to the target router.

12. The network distribution apparatus according to claim 11, wherein the processor, after sending the first access request to the target router, is configured to:
control the communication interface to receive an error feedback sent from the router, wherein the error feedback is used to indicate that the target router fails to identify the SSID of the target router encoded in the first encoding method;
control the communication interface to send a second access request to the target router, wherein the second access request comprises the SSID of the target router encoded in the second encoding method and the password of the target router; and
control the communication interface to receive an access feedback sent from the target router, wherein the access feedback is used to indicate a successful access to the target router.

13. The network distribution apparatus according to claim 9, wherein the processor is configured to:
obtain the network distribution data of the target router sent from the second terminal from a wireless fidelity (WiFi) target frame and target sequence of the target router.

14. The network distribution apparatus according to claim 13, wherein the processor is configured to:
obtain auxiliary information from the target frame, wherein the auxiliary information comprises at least one of: a string length of the target sequence, a check value of the SSID, and indicative information of an encoding method of the SSID; and
determine, according to the auxiliary information, the SSID of the target router encoded in the first encoding method and the SSID of the target router encoded in the second encoding method from the target sequence.
